(19) United States
(12) Patent Application Publication
(10) Pub. No.: US 2012/0063678 A1
(43) Pub. Date: Mar. 15, 2012

(54) GEOMETRIC IMAGE COMPRESSION

(75) Inventor: JOONAS ASIKAINEN, Zurich (CH)

(73) Assignee: Rovi Technologies Corporation

(21) Appl. No.: 12/881,981

(22) Filed: Sep. 14, 2010

(51) Int. Cl. G06K 9/36; G06K 9/00

(52) U.S. Cl. 382/165; 382/166

(57) ABSTRACT

An exemplary geometric image compression method includes identifying an image having a plurality of pixels, and iteratively obtaining largest geometric shapes by using corresponding reference points until all pixels of the image are processed. Each geometric shape includes at least a substantial portion of pixels with color values corresponding to a color value of a corresponding reference point. The method further includes generating, for each obtained geometric shape, identifying information including data indicative of a color value of the corresponding reference point or the average of the color values of at least the substantial portion of pixels within the geometric shape, data indicative of a location of the geometric shape, and data indicative of a size of the geometric shape, and storing compressed image data comprising identifying information of each obtained geometric shape.

### FIELD OF INVENTION

Embodiments of the present invention relate to data processing, and more specifically, to image compression.

### BACKGROUND

A digital image is generally a representation of a real image (e.g., a photograph) in a format which may be processed by a computer system. A digital image may be categorized into three general categories: black and white (e.g., binary) images, grayscale (e.g., monochromatic) images, and color images. Black and white images generally contain only the colors black and white, when displayed. Grayscale images generally contain the colors black, white and gray, when displayed. In grayscale images, any number of shades of the color gray may be contained within the image. Color images generally contain a variety of colors (e.g., yellow, orange, purple, etc.) including the colors black, white, and gray, when displayed. A digital image generally comprises a plurality of picture elements (e.g., pixels) arranged in a two-dimensional array. Each pixel may have a color and/or a color value associated with the pixel. Information associated with the location and color of each pixel may be stored and/or used by a computer system to display the digital image.

Digital images may be stored (e.g., stored as an image file) in storage areas (e.g., memory, hard disks) of a computer system. A digital image may comprise hundreds, thousands, or even millions of pixels and the location and color value of each pixel may be stored in the storage areas. This may result in less free space on the storage areas. Thus, there is a need to reduce the amount of space used by digital images in the storage areas.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of an exemplary network architecture in which embodiments of the invention may operate.

FIG. 2A is a block diagram of one embodiment of a geometry-based compression manager.

FIG. 2B is a block diagram of one embodiment of a geometry-based decompression manager.

FIG. 3 is a flow diagram of one embodiment of a method for lossless geometric image compression.

FIG. 4 illustrates one embodiment of a lossless geometric compression algorithm.

FIG. 5 is a flow diagram of one embodiment of a method for lossless fuzzy geometric image compression.

FIG. 6 illustrates one embodiment of a lossless fuzzy geometric compression algorithm.

FIG. 7 is a flow diagram of one embodiment of a method for lossy geometric image compression.

FIG. 8A illustrates use of different geometric shapes in compression of an image, in accordance with some embodiments of the invention.

FIG. 8B illustrates an optimization of a geometric image compression method, in accordance with some embodiments of the invention.

FIG. 9 is a flow diagram of one embodiment of a method for geometric reconstruction of an image.

FIG. 10 illustrates an exemplary computer system operating in accordance with some embodiments of the invention.

### DETAILED DESCRIPTION

Methods and systems for geometric image compression are described. An image may be a black and white (e.g., binary) image, a grayscale (e.g., monochromatic) image or a color image. A compression manager may obtain a first largest geometric shape (e.g., square, rectangle, etc.) in the image using a reference point, where at least a substantial portion of pixels within the first geometric shape has color values that correspond to a color value of the reference point. A color value of a pixel can correspond to the color value of the reference point by matching the color value of the reference point or by being within a threshold from the color value of the reference point. Next, the compression manager encodes the first geometric shape by using the color value of the reference point or the average of the color values of at least the substantial portion of pixels within the first geometric shape, the size of the first geometric shape and the location of the first geometric shape. Further, the compression manager repeats the above operations until all the pixels of the image are processed, and then stores the resulting compressed image data in a data store. The resulting compressed image data includes an encoding of each geometric shape obtained by the compression manager.

Accordingly, embodiments of the present invention eliminate redundancy of data within an image region defined by a geometric shape, and encode such image regions in an efficient fashion. The size of the resulting compressed image data is significantly smaller than the size of the original data points of the image.

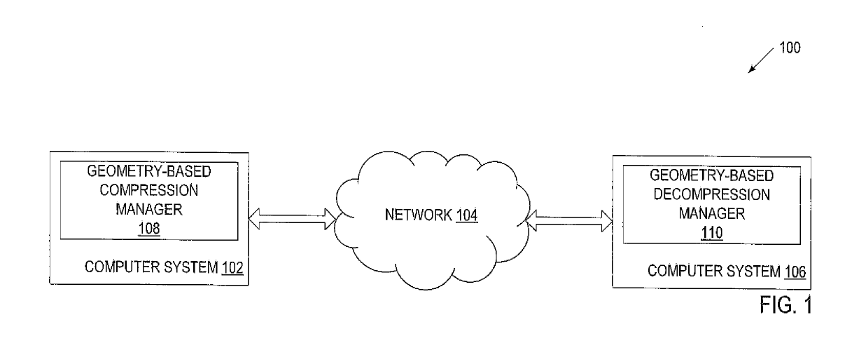

FIG. 1 is a block diagram of exemplary network architecture 100 in which embodiments of the invention may operate. The network architecture 100 may include a computer system 102 coupled to a computer system 106 via a network 104 (e.g., public network such as the Internet or private network such as a local area network (LAN)). Each of computer systems 102 and 106 may be a client, a server, or a node in a peer-to-peer network. In addition, computer systems 102 and 106 can include, for example, a server computer, a router computer, a personal computer, a portable digital assistant, a mobile phone, a laptop computer, a tablet computer, a camera, a video camera, a netbook, notebooks, a desktop computer, a media center, or any combination of the above.

The computer system 102 includes a geometry-based compression manager 108 that compresses images prior to transferring them to computer system 106 and/or other machines, thus reducing the size of data being transmitted. Alternatively or in addition, the geometry-based compression manager 108 can compress images prior to storing them on local storage devices (e.g., main memory, magnetic or optical storage based disks, tapes or hard drives) or network-based storage devices (e.g., network-attached storage (NAS) or storage area network (SAN)), thus reducing the amount of storage space needed to store image data. The computer system 106 may include a geometry-based decompression manager 110 to reconstruct images from the compressed image data generated by the geometry-based compression manager 108.

It should be noted that in some embodiments, computer system 102 and computer system 106 are part of the same machine that uses geometry-based compression manager 108 to store image data in an efficient form and uses the geometry-based decompression manager 110 to reconstruct original images from the stored data.

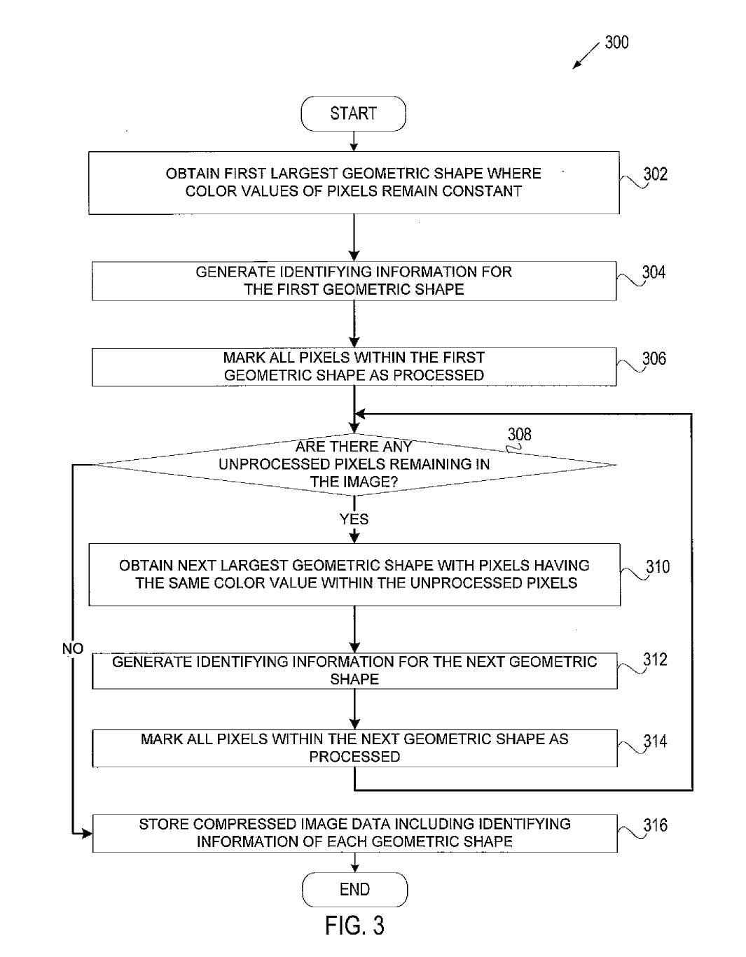

The geometry-based compression manager 108 compresses an image by reducing redundancy of data in image regions defined by geometric shapes, and generating an efficient encoding for each geometric shape. In one embodiment, the geometry-based compression manager 108 uses a lossless compression algorithm (“first compression algorithm”) that obtains the largest possible geometric shapes in which color values of all pixels remain constant. In another embodiment, the geometry-based compression manager 108 uses a lossless fuzzy compression algorithm (“second compression algorithm”) that obtains the largest possible geometric shapes in which color values of a significant number of pixels remain constant. In yet another embodiment, the geometry-based compression manager 108 uses a lossy compression algorithm (“third compression algorithm”) that obtains the largest possible geometric shapes in which color values of a significant number of pixels vary insubstantially (e.g., within a predefined threshold). In still another embodiment, the geometry-based compression manager 108 decides which of the above algorithms should be used depending on the type of image that needs to be compressed. For example, the geometry-based compression manager 108 may use the first lossless compression algorithm for black and white images (e.g., scanned text images), the second lossless compression algorithm for grayscale images, and the lossy compression algorithm for grayscale and color images. Some embodiments of the above algorithms are discussed in more detail below in conjunction with FIGS. 3 through 7.

The geometry-based decompression manager 110 processes each encoding included in the compressed image data to reconstruct pixels of a respective geometric shape. As discussed in more detail below, the reconstruction process may vary depending on the image compression algorithm that was utilized in the compression.

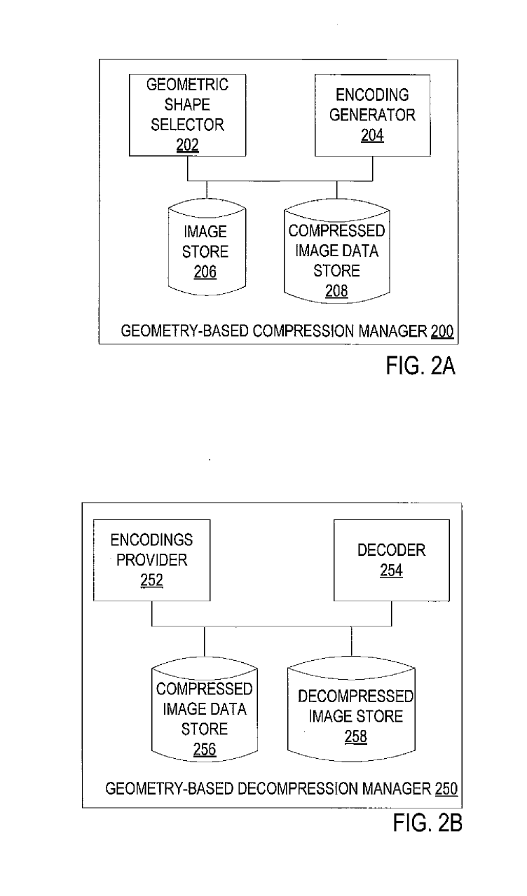

FIG. 2A is a block diagram of one embodiment of a geometry-based compression manager 200. The geometry-based compression manager 200 may be the same as the geometry-based compression manager 108 of FIG. 1 and may include a geometric shape selector 202, an encoding generator 204, an image store 206 and a compressed image data store 208.

The image store 206 may be a temporary buffer or a permanent data store to hold an image that needs to be compressed. The geometric shape selector 202 iteratively searches for largest geometric shapes in the pixels of the image. Depending on the compression algorithm being used, the geometric shape selector 202 may search for a first largest geometric shape with all pixels having the same color values, and then repeat the search using unprocessed pixels until all image pixels are processed. In an alternative embodiment, the geometric shape selector 202 may search for largest geometric shapes, where each geometric shape has a substantial number of pixels with the same color values, and then search for additional geometric shapes in each processed geometric shape by using the remaining pixels (pixels that have different color values) within a relevant geometric shape. In yet alternative embodiment, the geometric shape selector 202 may search for largest geometric shapes, where each geometric shape includes a substantial number of pixels having slightly varied color values (within a predefined threshold), and then search for additional geometric shapes in each processed geometric shape by using the remaining pixels (pixels that didn't satisfy the threshold requirement) within a relevant geometric shape.

The encoding generator 204 generates identifying information for each processed geometric shape. The identifying information (also referred to herein as an “encoding”) may include the position of a geometric shape within the image (e.g., using “x” and “y” axes), the size of the geometric shape, and a color value associated with the geometric shape. The encoding generator 204 stores compressed image data including identifying information of each processed geometric shape in the compressed image data store 208, which may be hosted by one or more storage devices (e.g., main memory, magnetic or optical storage based disks, tapes or hard drives, NAS, SAN, etc.).

FIG. 2B is a block diagram of one embodiment of a geometry-based decompression manager 250. The geometry-based decompression manager 250 may be the same as the geometry-based decompression manager 110 of FIG. 1 and may include an encoding provider 252, a decoder 254, a compressed image data store 256, and a decompressed image store 258.

The compressed image data store 256 stores compressed image data received over a network or generated by a local geometry-based image compression manager (e.g., manager 200 of FIG. 2). The compressed image data store 256 may be a temporary buffer or a permanent data store hosted by one or more storage devices (e.g., main memory, magnetic or optical storage based disks, tapes or hard drives, NAS, SAN, etc.).

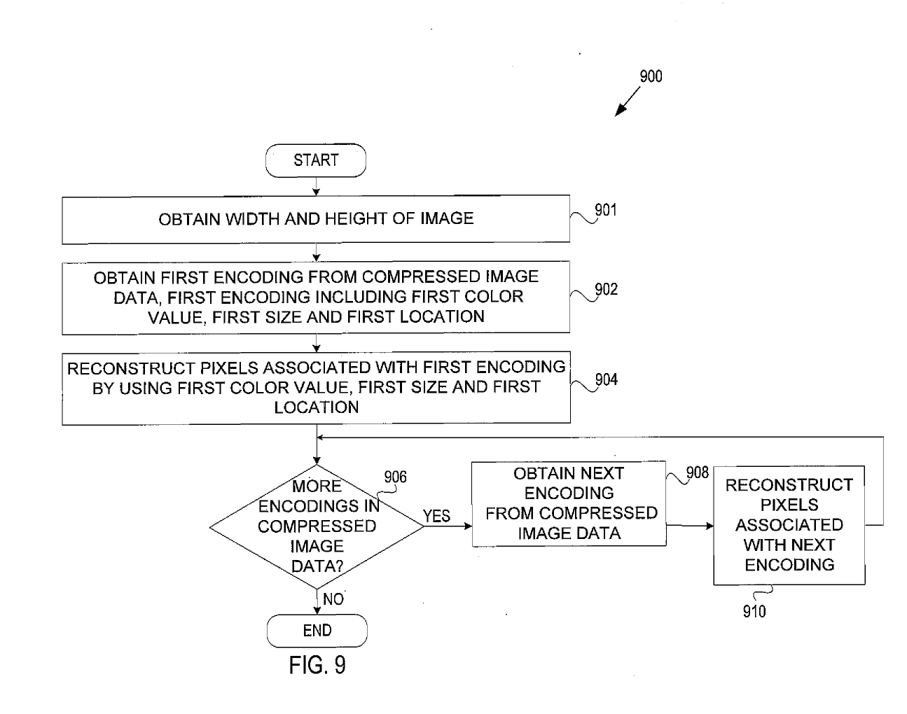

The encodings provider 252 obtains encodings associated with geometric shapes of the original image and passes the encodings to the decoder 254. The decoder 254 reconstructs pixels of relevant geometric shapes by using corresponding encodings, and stores the reconstructed image in the decompressed image store 258, which may be a temporary buffer or a permanent data store. An encoding may include the position of the geometric shape in the image, the size of the geometric shape and a color value associated with the geometric shape. Based on this information, the decoder 254 knows the position of pixels being reconstructed, the number of these pixels, and their color values. Some embodiments of geometric image decompression are discussed in more detail below in conjunction with FIG. 9.

FIGS. 3, 5 and 7 are flow diagrams that illustrate a method for geometric image compression. The method is performed by processing logic that may comprise hardware (circuitry, dedicated logic, etc.), software (such as is run on a general purpose computer system or a dedicated machine), or a combination of both. In one embodiment, embodiments of the method are performed by a computer system (e.g., a geometry-based compression manager 108 hosted by computer system 102 of FIG. 1).

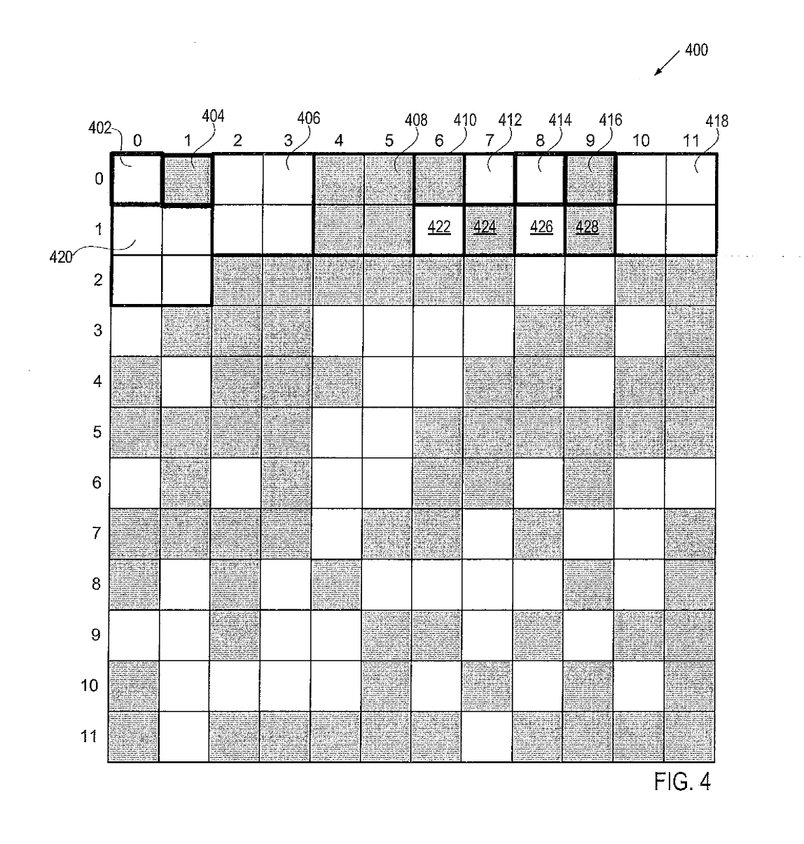

Referring to FIG. 3, a method 300 for lossless geometric image compression is discussed in conjunction with FIG. 4, which illustrates an image 400. For simplicity, image 400 is shown to have 121 (11×11) pixels; however, the method 300 can be used with images of any size without loss of generality.

Method 300 begins with a compression manager (e.g., geometry-based compression manager 108) obtaining a first largest geometric shape where color values of pixels remain constant. A geometric shape can be a square, a rectangle, a triangle, a circle, etc.

In one embodiment, illustrated in FIG. 4, the geometric shape is a square. As shown, compression starts with pixel 402 at the upper left corner of the image as a reference point (x_{—}0, y_{—}0) and continues along X axis. A color value of pixel 402 is 0 (white). Next pixel 404 (x_{—}1,y_{—}0) has a color value of 1 (black). Hence, the first largest square of image 400 consists of a single pixel, pixel 402.

At block 304, the compression manager generates identifying information for the first geometric shape. The identifying information can be an integer including the position of the first geometric region, the size of the first geometric region, and the color value of the reference point. Referring to FIG. 4, the identifying information of the first square 402 can be expressed as (0,0;1;0).

At block 306, the compression manager marks all pixels within the first geometric shape as processed. Referring to FIG. 4, the compression manager marks only pixel 402 as processed.

At block 308, the compression manager determines whether there are any unprocessed pixels remaining in the image. If not, the compression manager stores compressed image data comprising identifying information of each geometric shape (block 316). If so, the compression manager obtains the next largest geometric shape where the pixels remain constant (block 310). As shown in FIG. 4, the next largest square consists if a single pixel 404 with a color value of 1 (black).

At block 312, the compression manager generates identifying information for the next geometric shape. Referring to FIG. 4, the identifying information of the square 404 can be expressed as (1,0;1;1).

At block 314, the compression manager marks all pixels within the next geometric shape as processed. Referring to FIG. 4, the compression manager marks pixel 404 as processed. The next largest square is square 406 consisting of four (2×2) white pixels. The identifying information of the square 406 can be expressed as (2,0;2;0). The subsequent largest square is square 408 consisting of four (2×2) black pixels. The identifying information of the square 408 can be expressed as (4,0;2;1). Further largest squares along X axis are squares 410, 412, 414, 416 and 418. Once the last square at y_{—}0 is processed, compression continues at y_{—}1 by using only unprocessed pixels. Hence, at y_{—}1, the largest squares along X axis are 420, 422, 424, 426 and 428. These operations continue until all the pixels of image 400 are processed.

As discussed above, at block 316, the compression manager stores compressed image data including identifying information of each processed square of the image. In addition, the compressed image data may include the width and height of the original image. In one embodiment, the compressed image data is an integer valued array of size equal to the number of obtained geometric shapes plus two for the original image's width and height.

Based on multiple experiments, the lossless geometric compression algorithm discussed in conjunction with FIG. 4 achieves compression to 3-5% of data points of an original black and white image. It should be noted that image compression does not need to start at the upper left corner. It can start at any other corner of the image and can proceed from top to bottom along either X axis or Y axis, or from bottom to top along either X axis or Y axis, without loss of generality.

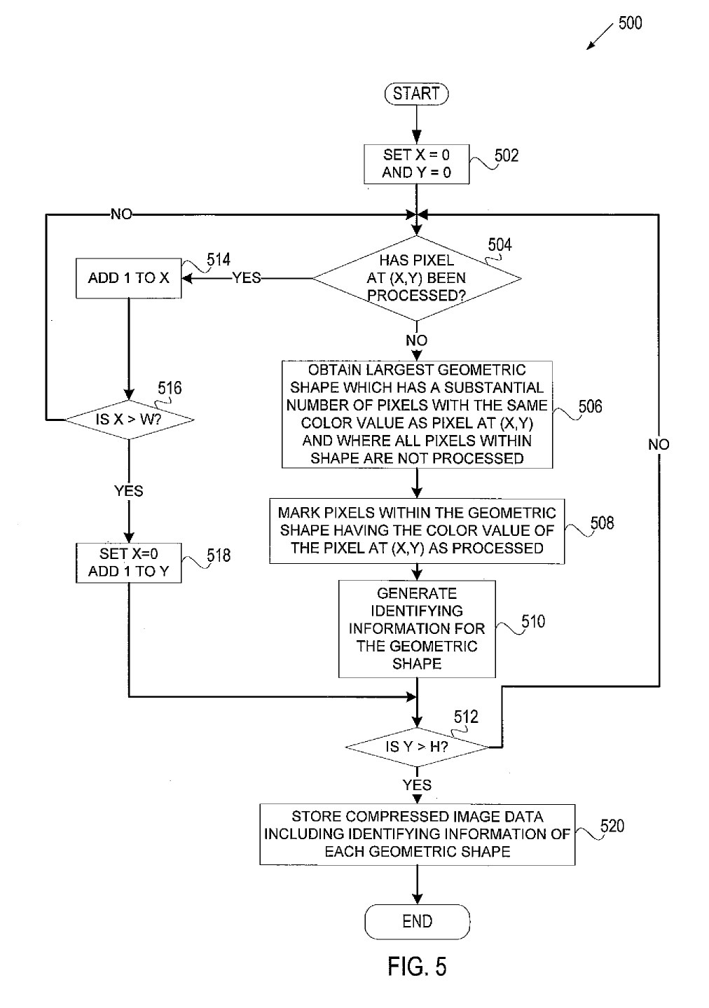

FIG. 5 is a flow diagram of one embodiment of a method 500 for lossless fuzzy geometric image compression. An image being processed has a width “W” and a height “H.” A compression manager (e.g., geometry-based compression manager 108) processes pixels of the image by using “X” and “Y” axes to specify positional information of a pixel within the image.

Referring to FIG. 5, method 500 starts by setting “X” and “Y” to zero (block 502). At block 504, the compression manager determines whether the pixel located at (X, Y) has been processed. If not, the compression manager obtains the largest geometric shape by using the pixel at (X, Y) as a reference pixel, where a substantial number of pixels within the geometric shape has the same color value as the reference pixel and where none of the pixels within the geometric shape have been processed (block 506). In one embodiment, the number of pixels with the same color value is considered to be substantial if it exceeds a predefined threshold (e.g., more than 50 percent).

At block 506, the compression manager marks the pixels within the geometric shape that have the color value matching the color value of the reference pixel as processed. At block 510, the compression manager generates identifying information for the geometric shape by using the location of the reference pixel (X, Y), the size of the geometric shape, and the color value of the reference pixel.

At block 512, the compression manager determines whether the current value of Y is greater than H (e.g., the height of the image). If so, then there are no more unprocessed pixels in the image, and the method 500 ends after storing the resulting compressed image data in a data store (block 520). If the current value of Y does not exceed H, than there are pixels in the image that have not been processed yet, and the method 500 returns to block 504.

If at block 504, the compression manager determines that the pixel at (X, Y) has been already processed, the compression manager moves to the next pixel along X axis by incrementing the value of X by 1 (block 514). At block 516, the compression manager determines whether the incremented value of X is greater than W (the width of the image). If not, e.g., the updated value of X corresponds to a pixel inside the image, the compression manager returns to block 504 to continue with the pixel at (X,Y), which may be a pixel inside a previously processed geometric shape or a pixel outside of all the previously processed geometric shapes. Alternatively, if the compression manager determines that the incremented value of X is greater than W (e.g., the updated value of X is outside the image), the compression manager increments the value of Y by one and sets the value of X to zero (block 518). If the new value of Y is inside the image (e.g., if Y does not exceed H at block 512), the compression manager returns to block 504 to continue at the beginning of the next row of pixels within the image. If the new value of Y is outside the image, then the method 500 ends after storing the resulting compressed image data in a data store (block 520). In one embodiment, the resulting compressed image data also includes the original image's width and height. In one embodiment, the resulting compressed image data is an integer valued array of size equal to the number of obtained geometric shapes plus two for the original image's width and height.

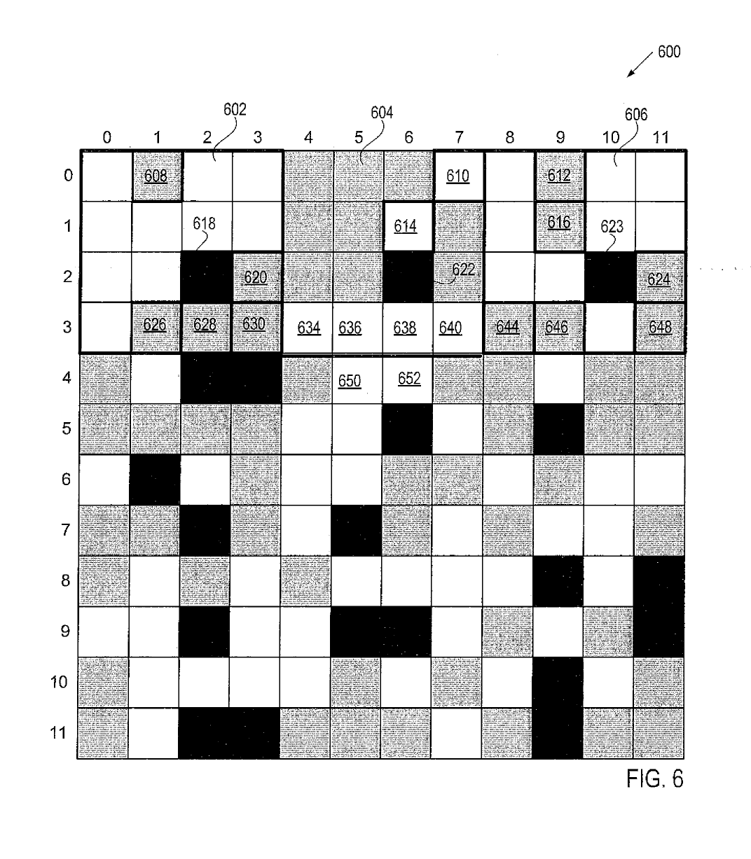

In one embodiment, as discussed below in conjunction with FIG. 6, the order of encoding unprocessed pixels, whether they reside within already encoded geometric shapes or outside of already encoded geometric shapes, is along X axis first, and along Y axis second. That is, all geometric shapes that are found along Y=0 (X=0, 1, 2, . . . N) are encoded first. Then, compression continues with Y=1 (X=0, 1, 2, . . . , N), etc. Alternatively, the order of encoding can be along Y axis first and along X axis second. Yet alternatively, the unprocessed pixels residing within already encoded geometric shapes can be handled differently from the approaches discussed herein. For example, once a first largest geometric shape is encoded, iterative handling of the unprocessed pixels inside this geometric shape is performed until all unprocessed pixels are encoded. After that, a search is performed for the next largest geometric shape outside of the first geometric shape, and so on.

One embodiment of method 500 is now discussed in conjunction with FIG. 6, which illustrates an image 600. For simplicity, image 600 is shown to have 121 (11×11) pixels; however, the method 500 can be used with images of any size without loss of generality.

As shown, square 602 includes 16 pixels (4×4), with 10 pixels having the same color (white) as the reference point at the upper left corner of the image. Based on multiple experiments, any number of unmatched pixels between ¼ and ½ of the total number of pixels in the square produces similar compression results. Hence, square 602 is the first largest square in which a substantial number of pixels have the color value matching the color value of the reference point. The identifying information of the square 602 can be expressed as (0,0;4;0). All pixels with color white within the square 602 are then marked as processed.

As shown, the square 602 has an unprocessed pixel 608 along axis Y=0. The encoding for the square 608 consisting of a single pixel can be expressed as (0,1;1;2). Once pixel 608 is processed, it is marked as processed.

The next unprocessed pixel along Y=0 is outside the square 602. Thus, the next largest square is 604. The identifying information of the square 604 can be expressed as (0,4;4;2). All pixels with color gray within the square 604 are then marked as processed. As shown, the square 604 has an unprocessed pixel 610 along axis Y=0. The encoding for the square 610 consisting of a single pixel can be expressed as (0,7;1;0). Once pixel 610 is processed, it is marked as processed.

The next unprocessed pixel along Y=0 is outside the square 604. Thus, the next largest square is 606. The identifying information of the square 606 can be expressed as (0,8;4;0). All pixels with color white within the square 606 are then marked as processed. As shown, the square 606 has an unprocessed pixel 612 along axis Y=0. The encoding for the square 612 consisting of a single pixel can be expressed as (0,9;1;2). Once pixel 612 is processed, it is marked as processed.

The method 500 now moves to Y=1. The encodings for unprocessed pixels 614 and 616 along Y=1 can be expressed as (1,6;1;0) and (1,9;1;2). The method 500 further moves to Y=2, where unprocessed pixels are 618, 620, 622, 623 and 624. Encodings for these pixels can be similarly generated. At Y=3, the unprocessed pixels are 626, 628, 630, 634, 636, 638, 640, 644, 646 and 648. Once encodings for these pixels are generated, the method 500 moves to Y=4 where the process continues in a similar manner until the entire image is encoded. In one embodiment, a new square is not allowed to extend beyond a previously encoded square. For example, pixels 636 and 638 from the square 604 cannot be combined with pixels 650 and 652 to generate a new square because such a new square undesirably extends beyond the square 604. In another embodiment, unmarked pixels from the previously processed square 604 can be combined with pixels outside the square 604 to generate a new largest square, in which a substantial number of pixels has the same color as a reference pixel (e.g., a square 4×4 with reference pixel 634), or in which all the pixels have the same color as a reference pixel (e.g., a square 2×2 with reference pixel 636).

The lossless fuzzy algorithm illustrated in FIG. 6 can be used for compression of black and white images, grayscale images and color images. For color (RGB) images, the algorithm can be performed separately for each of the red, green and blue components. This can be performed sequentially or in parallel.

Based on the experimental results, the lossless fuzzy algorithm illustrated in FIG. 6 enables representation of a grayscale image with about 60 percent of the original data points. In contrast, GZIP compression of JPEG images reduces the file size only by a few percent.

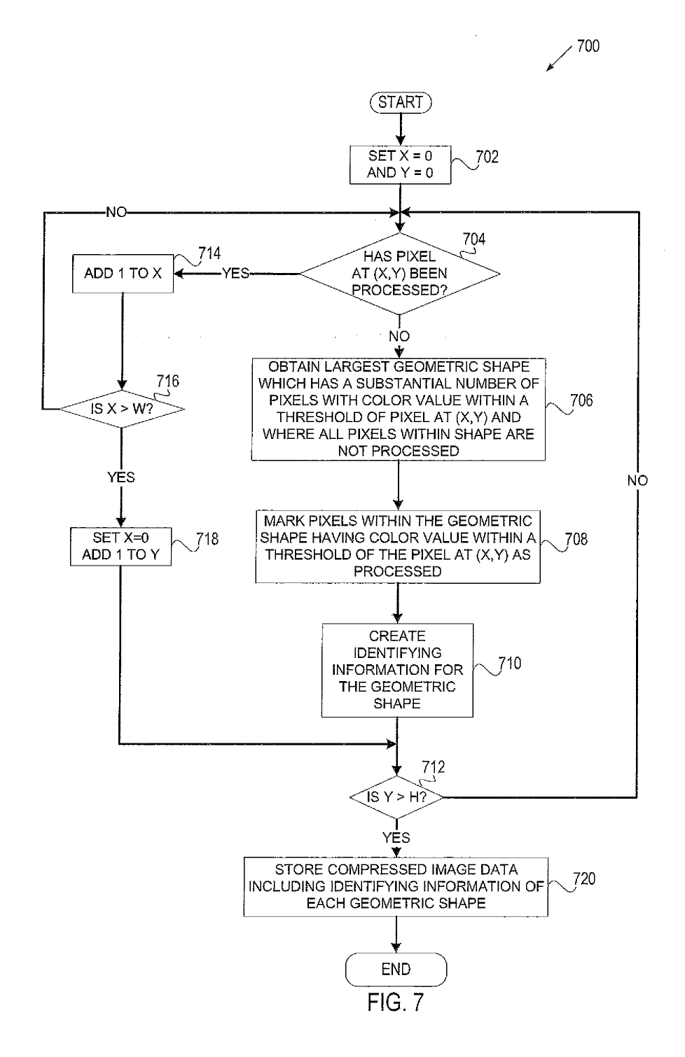

FIG. 7 is a flow diagram of one embodiment of a method 700 for lossy fuzzy geometric image compression. An image being processed has a width “W” and a height “H.” A compression manager (e.g., geometry-based compression manager 108) processes pixels of the image by using “X” and “Y” axes to specify positional information of a pixel within the image.

Referring to FIG. 7, method 700 starts by setting “X” and “Y” to zero (block 702). At block 704, the compression manager determines whether the pixel located at (X, Y) has been processed. If not, the compression manager obtains the largest geometric shape by using the pixel at (X, Y) as a reference pixel, where a substantial number of pixels within the geometric shape has color values within a threshold from a color value of the reference pixel and where none of the pixels within the geometric shape have been processed (block 706). In one embodiment, the number of pixels with the same color value is considered to be substantial if it exceeds a predefined threshold (e.g., more than 50 percent). In one embodiment, the threshold for allowing a variation in the color values of the pixels is defined by an integer valued tolerance parameter. Where the color value of a reference point is V_{—}0, a tolerance parameter can be expressed as t_v=0, 1, 2, 3, . . . . Choosing t_v=0 corresponds to the algorithm illustrated by FIG. 6. Increasing t_v to a value larger than 0 makes the intensity variation within the geometric shape coarser. Even though the image reconstructed from the compressed data is not equal to the original image, the modifications to the intensities remain local (within the geometric shape) and are spread out across the whole image. Based on multiple experiments with grayscale images, values t_v up to four do not seem to affect the quality of the image as viewed by the human eye.

At block 708, the compression manager marks pixels within the geometric shape that have the color value within a threshold from a color value of the reference pixel as processed. At block 710, the compression manager generates identifying information for the geometric shape by using the location of the reference pixel (X, Y), the size of the geometric shape, and a color value. In one embodiment, the color value is the color value of the reference pixel. Alternatively, the color value is the average color value of the pixels within the geometric shape that were marked as processed at block 708. For example, if four pixels within the geometric shape that were marked as processed have the color values 5, 7, 7, 5, the identifying information may include the average color value of 6. This alternative embodiment may result in a better spatial color balance between the compressed and original picture, especially in the case where there are color gradients.

At block 712, the compression manager determines whether the current value of Y is greater than H (e.g., the height of the image). If so, then there are no more unprocessed pixels in the image, and the method 700 ends after storing the resulting compressed image data in a data store (block 720). If the current value of Y does not exceed H, then there are pixels in the image that have not been processed yet, and the method 700 returns to block 704.

If at block 704, the compression manager determines that the pixel at (X, Y) has been already processed, the compression manager moves to the next pixel along X axis by incrementing the value of X by 1 (block 714). At block 716, the compression manager determines whether the incremented value of X is greater than W (the width of the image). If not, e.g., the updated value of X corresponds to a pixel inside the image, the compression manager returns to block 704 to continue with the pixel at (X,Y), which may be a pixel inside a previously processed geometric shape or a pixel outside all of the previously processed geometric shapes. Alternatively, if the compression manager determines that the incremented value of X is greater than W (e.g., the updated value of X is outside the image), the compression manager increments the value of Y by one and sets the value of X to zero (block 718). If the new value of Y is inside the image (e.g., if Y does not exceed H at block 712), the compression manager returns to block 704 to continue at the beginning of the next row of pixels within the image. If the new value of Y is outside the image, then the method 700 ends after storing the resulting compressed image data in a data store (block 720). In one embodiment, the compressed image data also includes the original image's width and height.

In one embodiment, the order of encoding unprocessed pixels, whether they reside within already encoded geometric shapes or outside of already encoded geometric shapes, is along X axis first, and along Y axis second. That is, all geometric shapes that are found along Y=0 (X=0, 1, 2, . . . N) are encoded first. Then, compression continues with Y=1 (X=0, 1, 2, . . . , N), etc. Alternatively, the order of encoding can be along Y axis first and along X axis second. Yet alternatively, the unprocessed pixels residing within already encoded geometric shapes can be handled differently from the approach discussed above in conjunction with FIG. 6. For example, once a first largest geometric shape is encoded, iterative handling of the unprocessed pixels inside this geometric shape is performed until all unprocessed pixels are encoded. After that, a search is performed for the next largest geometric shape outside of the first geometric shape, and so on.

Based on multiple experiments, an implementation of a lossy fuzzy compression system described herein enables representation of a grayscale image with about 20 percent of the original data points by using the tolerance of four color values within the geometric shapes.

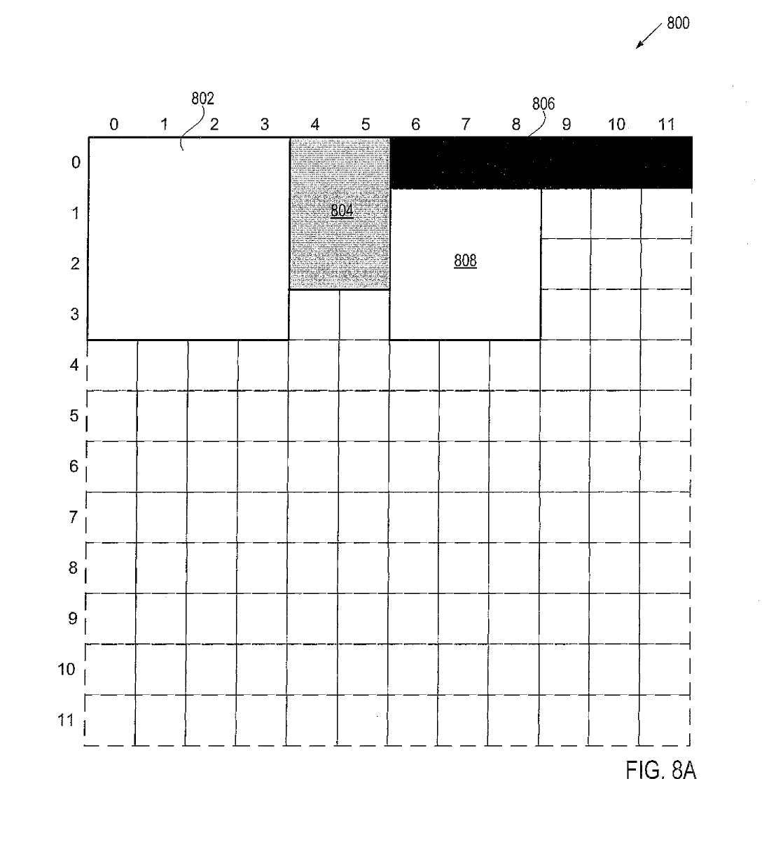

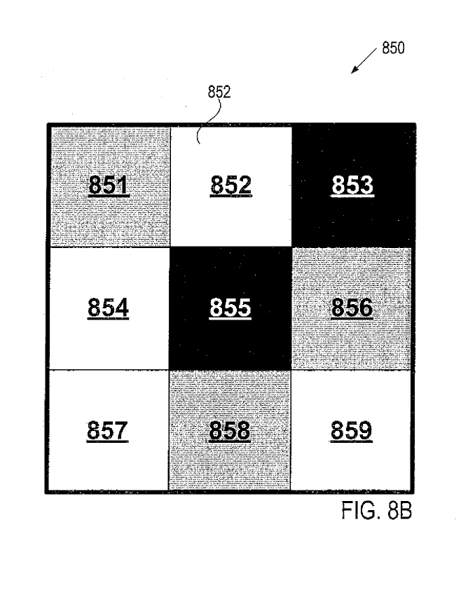

FIG. 8A illustrates use of different geometric shapes in compression of an image 800, in accordance with some embodiments of the invention. As shown in FIG. 5A, the largest geometric shapes obtained within image 800 can include a square 802, a rectangle 804, a rectangle 806, a square 808, and other geometric shapes. Encodings of geometric shapes can have a different format to represent the size of a geometric shape to allow accurate decompression. Specifically, the size of a geometric shape can be expressed using two components (width and height). For example, the encodings of shapes 802, 804, 806 and 808 can be expressed respectively as (0,0;4,4;0), (0,4;3,2;2), (0,6;1,6;1) and (1,6;3,3;0).

When compressing images by using compression methods discussed above in conjunction with FIG. 5 or FIG. 7), the resulting geometric shapes may include a relatively large number of geometric shapes consisting of a single pixel, which require individual encodings. FIG. 8B illustrates an optimization method for decreasing the number of separate encodings of individual pixels resulting from previously discussed compression methods.

Referring to FIG. 8B, a portion of an image is shown that consists of a square 850, where less than a substantial number of pixels has the same color value as a reference pixel 851. In particular, the reference pixel 851 is colored gray, as are pixels 856 and 858. Pixels 852, 854, 857, and 859 are colored white and pixels 853 and 855 are colored black.

FIG. 8B shows an exemplary case, in which the compression manager compresses an image by using a method discussed above in conjunction with FIG. 5 or 7, and reaches an unprocessed pixel 851 that can only form a single-pixel geometric shape because a larger shape would not have a substantial number of pixels with color values that match the color value of pixel 851 (method of FIG. 5) or with color values that are within a threshold from the color value of pixel 851 (FIG. 7). According to one embodiment of compression optimization illustrated in FIG. 8B, upon detecting such a pixel 851, the compression manager examines unprocessed pixels in the immediate neighborhood of pixel 851 that form a larger geometric shape (e.g., a 3 by 3 square 850 with the reference pixel 851 at the upper left corner). If the compression manager finds, within square 850, any pixels that have the same color value as the reference pixel 851 (method of FIG. 5) or any pixels with a color value within a threshold from the reference pixel 851 (method of FIG. 7), the compression manager marks these pixels as processed and encodes these pixels by using a single integer. In the example of FIG. 8B, the pixel 851 shares the color value with pixels 856 and 858. The compression manager can mark the pixels 851, 856 and 858 as processed, and generate identifying information for the pixels 851, 856 and 858.

In one embodiment, the compression manager generates identifying information which provides data indicating the locations of pixels 851, 856 and 858 within the square 852 and data indicating which of the remaining eight pixels (e.g., pixels 852 through 858) have the same color as the reference pixels 851 (e.g., pixels 866 and 858). In one embodiment, the bit string is constructed where the number of bits in the bit string is one less than the number of pixels in the square 850, where the bit locations in the bit string are associated with the location of the pixels in the square 850. In the bit string, a value “0” in a bit position may indicate that the pixel at the corresponding location within square 850 does not have the same color as the reference pixel 851, and a value “1” in the bit position may indicate that the pixel at the corresponding location within square 850 does have the same color as the reference pixel. The compression manger may generate a bit string {0, 1, 0, 1, 0, 0, 0, 0}, going from bottom to top of the square 850 and from right to left in each row of the square 850 such that the left most bit position in the bit string is associated with the pixel 859 and the right most bit position in the bit string is associated with the pixel 852. The reference pixel 851 is not part of the bit string. However, alternatively, the reference pixel may be added to the bit string at the light end of the bit string, resulting in a total of 9 bits in the bit string, with the last bit value being “1.”

The compression manager then converts the bit string {0, 1, 0, 1, 0, 0, 0, 0} to a decimal representation of the bit string, which is the integer value 80. The compression manager may use a negative value of the integer value (e.g., −80) when generating the identifying information, in order to distinguish this encoding of the square 850 from other encodings of geometric shapes that are generated using a compression method discussed above in conjunction with FIG. 5 or 7. The compression manager then includes the color value of the reference pixel 851 and the location of the reference pixel 851 within the image in the identifying information. For example, if the reference pixel 851 is located at X=50 and Y=75 within the image and the color gray is represented with the color value of 1, the identifying information for the square 850 can be expressed as (−80, 1; 50, 75) where “−80” represents the pixels within the square 850 with the same color as the reference pixel 851, “1” represents the color (gray) of the reference pixel 851, “50” represents the location of the reference pixel 851 in the image along the X-axis and “75” represents the location of the reference pixel 851 in the image along the Y-axis.

With respect to the compression method discussed above in conjunction with FIG. 7, the compression manager may generate a bit string for the square 850 where a value “0” in a bit position indicates that the pixel at the corresponding location within the square 850 does not have a color value within a threshold of the color value of the reference pixel 851 and a value “1” in the bit position indicates that the pixel at the corresponding location within the square 850 does have a color value within a threshold of the color value of the reference pixel 851. When generating identifying information, the compression manager may include data indicative of the color of the reference pixel 851 or data indicative of the average of color values of the pixels within the square 850 which have a color value within a threshold of the color value of the reference pixel 851.

In other embodiments, the bit string may be generated in different ways, for example, going from top to bottom of the square 850 and from left to right in each row of the square 850 such that the left most bit position in the bit string is associated with the pixel 852 and the right most bit position in the bit string is associated with the pixel 859. In another embodiment, a value “1” in a bit position may indicate that the pixel at the corresponding location within the square 850 does not have the same color value as the reference pixel 851 or does not have a color value within a threshold of the color value of the reference pixel 851, and a value “0” in the bit position may indicate that the pixel at the corresponding location within the square 850 does have the same color value as the reference pixel or does have a color value within a threshold of the color value of the reference pixel.

FIG. 9 is a flow diagram of one embodiment of a method 900 for geometric reconstruction of an image. The method 900 is performed by processing logic that may comprise hardware (circuitry, dedicated logic, etc.), software (such as is run on a general purpose computer system or a dedicated machine), or a combination of both. In one embodiment, method 900 is performed by a computer system (e.g., a geometry-based decompression manager 110 hosted by computer system 106 of FIG. 1).

Referring to FIG. 9, method 900 begins with a decompression manager (e.g., a geometry-based decompression manager 110) reading the width and height of the compressed image and allocating the matrix holding the pixels (block 901). Decompression manager then continues by obtaining a first encoding from compressed image data (block 902). The first encoding is associated with a first geometric shape and includes a color value associated with the first geometric shape, a size of the first geometric shape and a location of the first geometric shape.

At block 904, the decompression manager reconstructs pixels of the first geometric shape by using the color value, size and location of the first geometric shape. In particular, the decompression manager determines the number of pixels within the first geometric shape based on the specified size, adds the determined number of pixels to the specified location within the image, and provides the color of the added pixels based on the specified color value.

At block 906, the decompression manager determines whether there are more encodings in the compressed image data. If not, method 900 ends. If so, the decompression manager obtains the next encoding from the compressed image data (block 908) and reconstructs the pixels of a corresponding geometric shape in a manner described above (block 910). Blocks 906, 908 and 910 are repeated until all the encodings are processed. In one embodiment, the decoding is performed in the same order as the order in which the image was encoded. If a geometric shape in the original image included one or more other (smaller) geometric shapes within the big geometric shape, then the compressed image data includes an encoding of the big geometric shape and then an encoding of a smaller geometric shape(s). In such a case, the decompression manager first uses the encoding of the big geometric shape and assigns the corresponding color value (e.g., the color value of the reference point) to all pixels within the big geometric shape, and then the decompression manager uses the encoding of the smaller geometric shape and changes the color value of pixels within the smaller geometric shapes based on the color value included in the encoding of the smaller geometric shape.

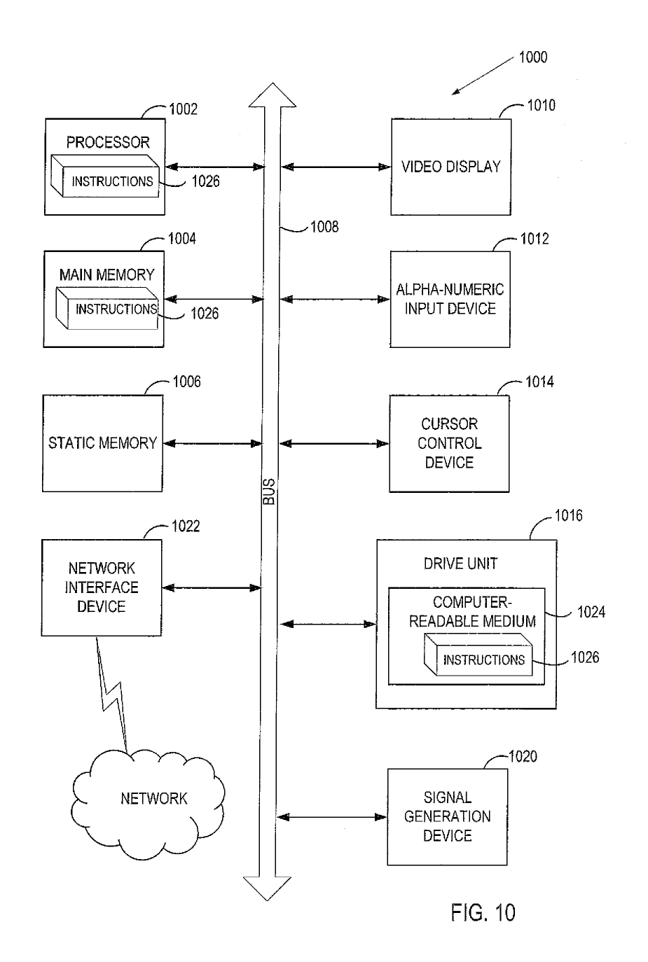

FIG. 10 illustrates an exemplary machine or computer within which a set of instructions, for causing the machine to perform any one or more of the methodologies discussed herein, may be executed. In alternative embodiments, the machine may be coupled (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary machine 1000 includes a processing system (processor) 1002, a main memory 1004 (e.g., read-only memory (ROM), flash memory, dynamic random access memory (DRAM) such as synchronous DRAM (SDRAM)), a static memory 1006 (e.g., flash memory, static random access memory (SRAM)), and a data storage device 1016, which communicate with each other via a bus 1006.

Processor 1002 represents one or more general-purpose processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 may also be one or more special-purpose processing devices such as an application specific integrated circuit (ASIC), a field programmable gate array (FPGA), a digital signal processor (DSP), network processor, or the like. The processor 1002 is configured to execute instructions 1026 of geometry-based compression manager 108 and/or geometry-based decompression manager 110 for performing the operations and steps discussed herein.

The machine 1000 may further include a network interface device 1022. The machine 1000 also may include a video display unit 1010 (e.g., a liquid crystal display (LCD) or a cathode ray tube (CRT)), an alphanumeric input device 1012 (e.g., a keyboard), a cursor control device 1014 (e.g., a mouse), and a signal generation device 1020 (e.g., a speaker).

The data storage device 1016 may include a computer-readable medium 1024 on which is stored one or more sets of instructions 1026 (e.g., instructions 1026 of geometry-based compression manager 108 and/or geometry-based decompression manager 110) embodying any one or more of the methodologies or functions described herein. The instructions 1026 of geometry-based compression manager 108 and/or geometry-based decompression manager 110 may also reside, completely or at least partially, within the main memory 1004 and/or within the processor 1002 during execution thereof by the machine 1000, the main memory 1004 and the processor 1002 also constituting computer-readable media. The instructions 1026 of geometry-based compression manager 108 and/or geometry-based decompression manager 110 may further be transmitted or received over a network 1020 via the network interface device 1022.

While the computer-readable storage medium 1024 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “detecting”, “determining”, “obtaining”, “reprogramming”, “establishing” or the like, refer to the actions and processes of a computer, or similar electronic computing device, that manipulates and transforms data represented as physical (e.g., electronic) quantities within the computer's registers and memories into other data similarly represented as physical quantities within the computer memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computer-implemented method comprising:
identifying an image comprising a plurality of pixels, each pixel having a color value;
obtaining a first largest geometric shape by using a first pixel as a first reference point, wherein color values of at least a substantial portion of pixels within the first largest geometric shape correspond to a color value of the first pixel;
generating identifying information for the first largest geometric shape by using:
data indicative of the color value of the first pixel or the average of the color values of at least the substantial portion of pixels within the first largest geometric shape,
data indicative of a location of the first largest geometric shape, and
data indicative of a size of the first largest geometric shape;
iteratively obtaining a next largest geometric shape starting with a next unprocessed pixel as a next reference point until the plurality of pixels of the image are processed, wherein color values of at least a substantial portion of pixels within the next largest geometric shape correspond to a color value of the next pixel;
for each next largest geometric shape, generating identifying information for the next largest geometric shape by using:
data indicative of the color value of the next pixel or the average of the color values of at least the substantial portion of pixels within the next geometric shape,
data indicative of a location of the next largest geometric shape, and
data indicative of a size of the next largest geometric shape; and
storing compressed image data comprising identifying information of each obtained geometric shape.

2. The method of claim 1, wherein color values of all pixels within the first largest geometric shape are the same as the color value of the first pixel.

3. The method of claim 1, wherein the first largest geometric shape and each next largest geometric shape comprise at least one of a square, a rectangle, a triangle, and a circle.

4. The method of claim 1, wherein color values of at least half of the pixels within the first largest geometric shape correspond to the color value of the first pixel.

5. The method of claim 4, wherein the at least half of the pixels within the first largest geometric shape are within a threshold from the color value of the first pixel.

6. The method of claim 1, wherein the image comprises at least one of a Joint Photographic Experts Group (JPEG) format, a graphics interchange format (GIF), a bitmap (BMP), a portable network graphics (PNG) format, a tagged image filed format (TIFF), and a raw image format.

7. The method of claim 1, wherein:
the color value of each pixel in the plurality of pixels comprises a red color value, a green color value and a blue color value; and
the plurality of pixels in the image are processed separately for each of the red, green and blue color values.

8. The method of claim 1, wherein the first pixel and each next pixel comprise the left most unprocessed pixel in the image starting from the top of the image.

9. The method of claim 4, further comprising:
while processing the first largest geometric shape, refraining from processing unmatched pixels within the first largest geometric shape, the unmatched pixels having pixel values that do not correspond to the color value of the first pixel;
after processing the first largest geometric shape, obtaining one or more subsequent geometric shapes by using the unmatched pixels, creating identifying information for each subsequent geometric shape, and adding the identifying information of each subsequent geometric shape to the compressed image data.

10. An apparatus comprising:
a memory to store an image comprising a plurality of pixels;
a processor, coupled to the memory; and
a compression manager, executed from the memory by the processor to:
obtain a first largest geometric shape by using a first pixel as a first reference point, wherein color values of at least a substantial portion of pixels within the first largest geometric shape correspond to a color value of the first pixel;
generate identifying information for the first largest geometric shape by using data indicative of the color value of the first pixel or the average of the color values of at least the substantial portion of pixels within the first largest geometric shape, data indicative of a location of the first largest geometric shape, and data indicative of a size of the first largest geometric shape;
iteratively obtain a next largest geometric shape by using a next unprocessed pixel as a next reference point until the plurality of pixels of the image are processed, wherein color values of at least a substantial portion of pixels within the next largest geometric shape correspond to a color value of the next pixel;
for each next largest geometric shape, generate identifying information for the next largest geometric shape by using:
data indicative of the color value of the next pixel or the average of the color values of at least the substantial portion of pixels within the next largest geometric shape,
data indicative of a location of the next largest geometric shape, and
data indicative of a size of the next largest geometric shape; and
store compressed image data comprising identifying information of each obtained geometric shape in the memory.

11. The apparatus of claim 10, wherein color values of all pixels within the first largest geometric shape are the same as the color value of the first pixel.

12. The apparatus of claim 10, wherein color values of at least half of the pixels within the first largest geometric shape correspond to the color value of the first pixel.

13. The apparatus of claim 12, wherein the at least half of the pixels within the first largest geometric shape are within a threshold from the color value of the first pixel.

14. The apparatus of claim 10, wherein:
the color value of each pixel in the plurality of pixels comprises a red color value, a green color value and a blue color value; and
the plurality of pixels in the image are processed separately for each of the red, green and blue color values.

15. The apparatus of claim 12, further comprising:
while processing the first largest geometric shape, refraining from processing unmatched pixels within the first largest geometric shape, the unmatched pixels having pixel values that do not correspond to the color value of the first pixel;
after processing the first largest geometric shape, obtaining one or more subsequent geometric shapes by using the unmatched pixels, generating identifying information for each subsequent geometric shape, and adding the identifying information of each subsequent geometric shape to the compressed image data.

16. A computer readable storage medium including instructions that, when executed by a processing system, cause the processing system to perform a method comprising:
identifying an image comprising a plurality of pixels, each pixel having a color value;
obtaining a first largest geometric shape by using a first pixel as a first reference point, wherein color values of at least a substantial portion of pixels within the first largest geometric shape correspond to a color value of the first pixel;
generating identifying information for the first largest geometric shape by using:
data indicative of the color value of the first pixel or the average of the color values of at least the substantial portion of pixels within the first largest geometric shape,
data indicative of a location of the first largest geometric shape, and
data indicative of a size of the first largest geometric shape;
iteratively obtaining a next largest geometric shape by using a next unprocessed pixel as a next reference point until the plurality of pixels of the image are processed, wherein color values of at least a substantial portion of pixels within the next largest geometric shape correspond to a color value of the next pixel;
for each next largest geometric shape, generating identifying information for the next largest geometric shape by using:
data indicative of the color value of the next pixel or the average of the color values of at least the substantial portion of pixels within the first largest geometric shape,
data indicative of a location of the next largest geometric shape, and
data indicative of a size of the next largest geometric shape; and
storing compressed image data comprising identifying information of each obtained geometric shape.

17. The computer readable storage medium of claim 16, wherein color values of all pixels within the first largest geometric shape are the same as the color value of the first pixel.

18. The computer readable storage medium of claim 16, wherein color values of at least half of the pixels within the first largest geometric shape correspond to the color value of the first pixel.

19. The computer readable storage medium of claim 18, wherein the at least half of the pixels within the first largest geometric shape are within a threshold from the color value of the first pixel.

20. The computer readable storage medium of claim 16, wherein:
the color value of each pixel in the plurality of pixels comprises a red color value, a green color value and a blue color value; and
the plurality of pixels in the image are processed separately for each of the red, green and blue color values.

21. The computer readable storage medium of claim 18, wherein the method further comprises:
while processing the first largest geometric shape, refraining from processing unmatched pixels within the first largest geometric shape, the unmatched pixels having pixel values that do not correspond to the color value of the first pixel;
after processing the first largest geometric shape, obtaining one or more subsequent geometric shapes by using the unmatched pixels, generating identifying information for each subsequent geometric shape, and adding the identifying information of each subsequent geometric shape to the compressed image data.

22. A computer-implemented method comprising:
obtaining a first encoding from compressed image data the compressed image data comprising a plurality of encodings associated with largest geometric shapes within an image, the first encoding including a first color value, a first size of a first largest geometric shape, and a first location of the first largest geometric shape;
reconstructing one or more pixels of the first largest geometric shape by using the first color value, the first size, and the first location;
iteratively obtaining a next encoding from the compressed image data until processing the last one of the plurality of encodings, the next encoding including a next color value, a next size of a next largest geometric shape, and a next location of the next largest geometric shape; and
for each next encoding, reconstructing one or more pixels of the next largest geometric shape by using the next color value, the next size, and the next location.
